(19) United States
(12) Patent Application Publication
(10) Pub. No.: US 2012/0042791 A1
(43) Pub. Date: Feb. 23, 2012

(54) Bean knife mount

(76) Inventor: John J. Misico, Ubly, MI (US)

(21) Appl. No.: 12/806,582

(22) Filed: Aug. 17, 2010

(51) Int. Cl. A23N 15/12

(52) U.S. Cl. 99/635

(57) ABSTRACT

The bean knife mount is a mounting device to mount bean knives that allow the user to mount the knives in a manner consistent with cutting the bean plant just below the surface of the earth. The angle of the mounts allows the knives to travel just below the soil line, cutting the plant very low, preventing the plant from being harvested to high up on its stalk. This eliminates loss of bean pods from the plant and increases the output and increasing profits.

### BACKGROUND OF THE INVENTION

The instant invention is a mount that allows the user to attach a mount to an existing bean harvester and mount bean knives thereon. Prior art harvesters have short cutting blades that run above the surface of the ground that cut the bean stalk high on the plant causing bean loss. The instant device allows the user to adjustably mount bean knives. The ability to mount the knives in an adjustable manner creates a situation where the user can place the knives in a position just below the soil line. With the knives just below the soil line the knives will cut the bean plant in a manner that will not inadvertently knock off or remove beans from the plant prior to being received by the harvester. This discovery eliminates waste and improves the harvested amount allowing the user to maximize earnings on the user investment.

### THE INVENTION

The instant invention is a novel mounting device for bean knives. The mounting device comprises in combination, a first flat metal plate that has four corners and a bottom, each corner having near it, an opening therethrough.

The first flat metal plate has permanently affixed to the bottom thereof, a second flat metal plate. This second flat metal plate is oriented vertically with regard to the flat plane of the bottom of the first flat metal plate. The second flat metal plate has at least two vertical slots therethrough.

There is a third flat metal plate that has five corners, and a top, wherein each corner has near it, an opening therethrough. The third flat metal plate has permanently affixed to the top thereof, a fourth flat metal plate. This fourth flat metal plate is oriented essentially at an angle with regard to the flat plane of the third flat metal plate. The fourth metal plate has at least two vertical slots therethrough that align with the vertical slots of the second flat metal plate. There is a mechanical fastener inserted through the each set of vertical slots to rigidly fasten the second flat metal plate and the fourth flat metal plate together. The angle of the fourth flat metal plate, relative to the flat plane of the top of the third flat metal plate, is within the range of 40° to 70°.

### BRIEF DESCRIPTION OF THE DRAWINGS

FIG. 1 is a top view of a portion of a bean harvester fitted with the bean knife mounts.

FIG. 2 is a side view of the bean knife mounts showing the ground level knives, and a portion of a bean harvester.

FIG. 3 is a side view in perspective of a mount.

FIG. 4 is a full frontal view of a mount showing the angular relationship between the top plate of the mount and the bottom plate of the mount.

FIG. 5 is a full side view in perspective of a mount that shows the vertical adjustability of the mount.

FIG. 6 is a full rear view in perspective of a mount.

FIG. 7 is a full bottom view of a mount showing the relationship between the angle of the top plate and the bottom plate.

FIG. 8 is a full top view of a mount.

FIG. 9 is a full side view of a mount and the position that it mounts relative to a bean harvester.

FIG. 10 is a full front view in perspective, of a pair of mounts with knives attached and the mounts being mounted to a harvester wherein a portion of the bean harvester and the knives are shown.

### DETAILED DESCRIPTION OF THE DRAWINGS

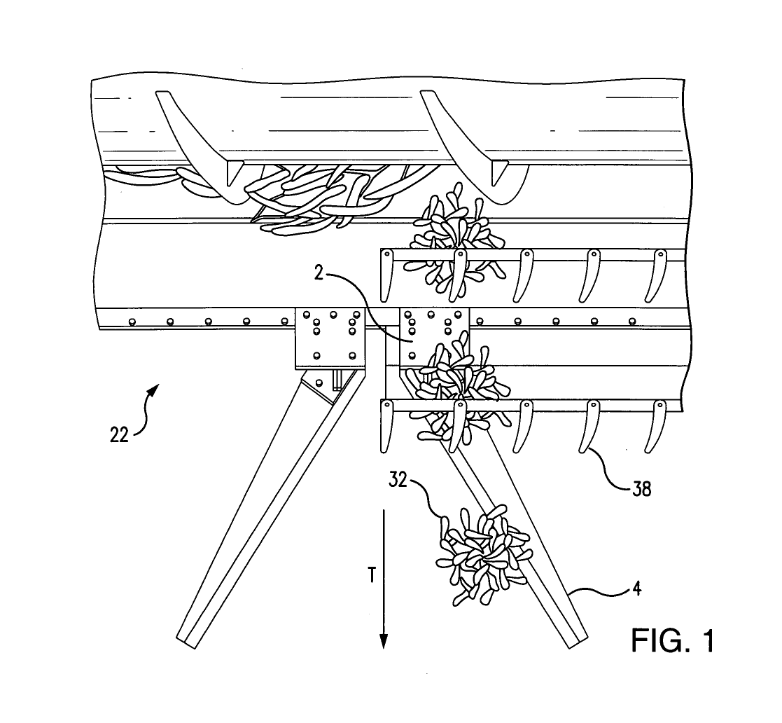

FIG. 1 is a top view of a harvester or combine 22 fitted with the bean knife mounts 2. Mounted on the mounts 2 are knives 4. The bean mounts 2 allow for a set of knives 4 to be mounted below the soil and directly harvest multiple rows at once. The row of beans 32 are cut by the inner edge or blades 44 of the knives 4 and the knives 4 direct the bean plant toward the harvester 22 where the reel fingers 38 pull then into the augur 26 where they continue into the harvester 22 where they are removed from their pods 36 and ready to be transferred into transportation equipment to be removed from the field.

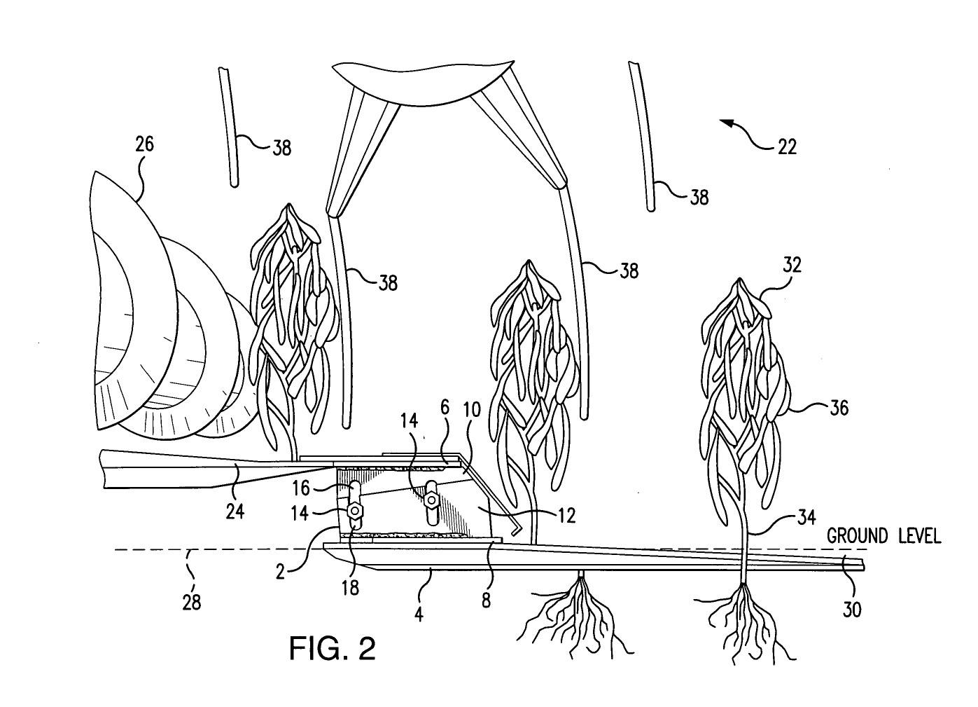

FIG. 2 is a side view of the bean knife mounts 2 showing the ground level 28, knives 4, and the harvester 22. This view shows how the knives 4 direct the bean plant 32 by its stalk 34 along the knives 4 to be cut. They are then gathered by the reel fingers 38 that direct them to the augur 26 and into the harvester 22. This view shows the knives 4 traveling below ground level 28 at a depth for harvesting 30. This is part of the discovery, that is, the utility of the instant invention, that is, cutting low on the bean stalk eliminating a possibility of losing bean pods 36 onto the ground. The prior art cutters travel above ground level 28 and because the fields are not level the cut is consistently high, creating a vibration and shaking of the bean plant, resulting in loss of product and profit.

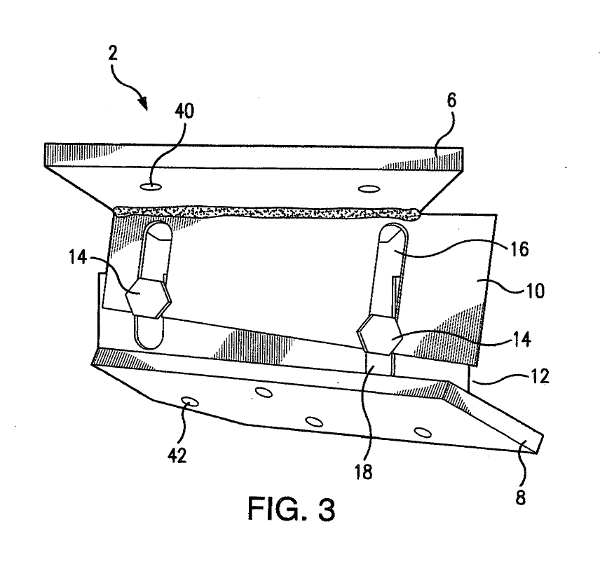

FIG. 3 is a side view of the mount 2. The header mount or top plate 6 of the bean knife mount 2 is attached to the knife mount or bottom plate 8 via the fasteners 14. Both the top plate 6 and the bottom plate 8 have risers 10 and 12. The top plate riser 10 is attached to the bottom plate riser 12 via the fasteners 14. Each riser 10 and 12 has elongated slots 16 and 18 respectively where the attachment takes place. There is a range of adjustability so the top plate 6 is adjustable in terms of its relationship with the bottom plate 8. This adjustability will allow the knives 4 to run below ground level 28. The top plate 6 has header mount openings therethrough 40 and the bottom plate 8 has knife mounting openings therethrough 42. Each allow the mount 2 be mounted to their respective attachments.

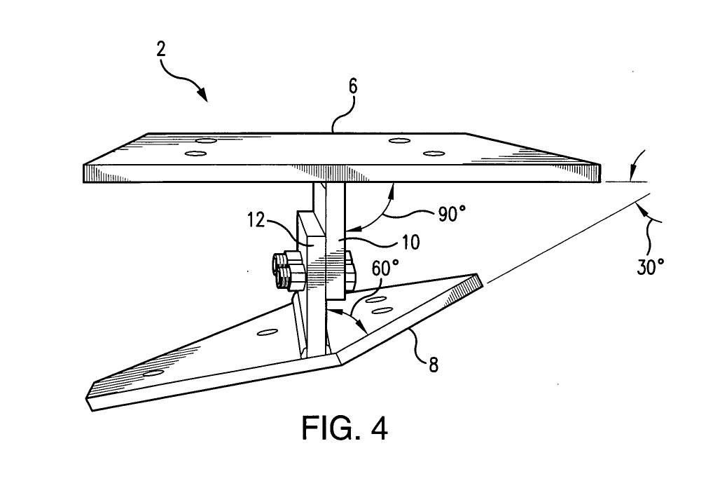

FIG. 4 is a front view of the mount 2 showing the angular relationship between the top plate 6 of the mount 2 and the bottom plate 8 of the mount 2. The angle of the top plate 6 and its riser 10 meet to form a 90° angle. The bottom plate 8 and its riser 12 meet to form a 60° angle. The continuation of the planes of their respective angles intersects to form a 30° angle.

The plates are adjustable to meet a range of 45° to 65° for the bottom plate 8. More preferably the range of the bottom plate 8 is 50° to 60°. Even more preferable is the angle of the bottom plate 8 being 50°. Ideally the preferred angle of the bottom plate is 60°.

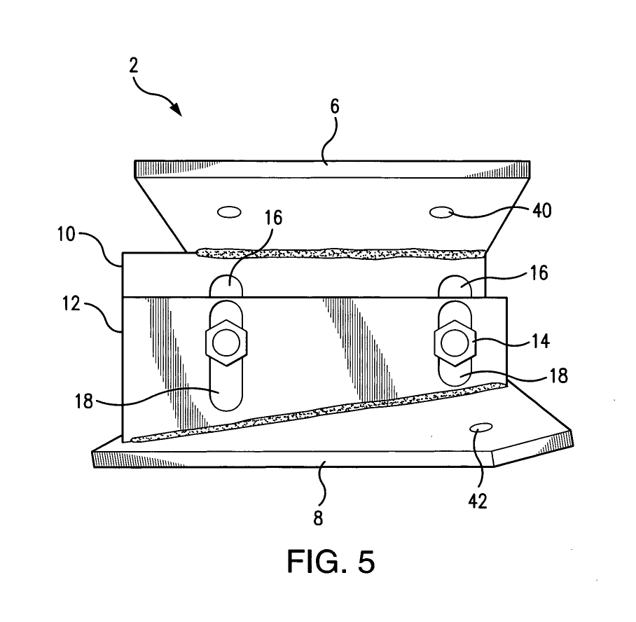

FIG. 5 is a side view of the mount 2 that shows the vertical adjustability of the mount 2. The top plate 6 has a riser 10 that is adjustably attached to the bottom plate 8 via its riser 12 by fasteners 14. The fasteners 14 when loose allow the risers 10 and 12 to slide closer or further apart via elongated opening therethrough 16 and 18 of each respective riser 10 and 12 depending on the needs of the user. Also visible are the header mounting openings 40 and the knife mounting openings 42.

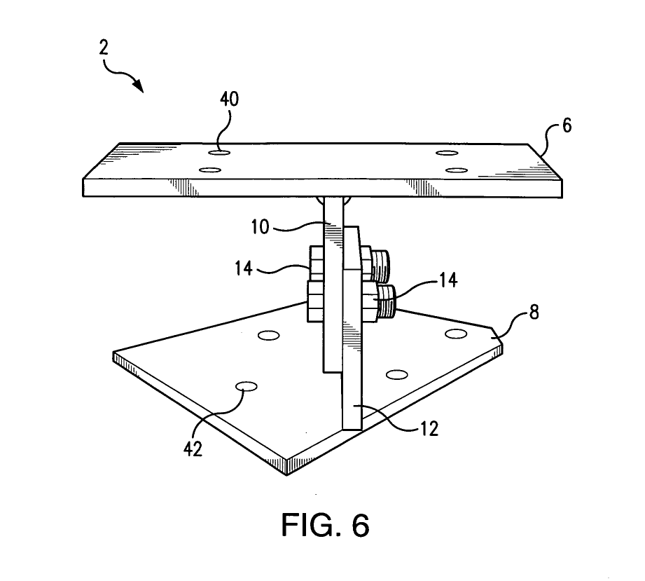

FIG. 6 is a rear view of the mount 2. This perspective shows the relationship between the top plate 6 and the bottom plate 8 as far as the angle of each knife 4 will take off from the header 24. With a pair of mounts 2 mounted the knives 4 will essentially form a V shape that will guide, and then direct the bean plants 32 toward the combine 22. As the beans move along the knives 4 they are cut upon arrival at the header 24 where they are drawn into the combine 22 by the reel fingers 38 and processed. It should be known that the right mount 2 is present here with the left mount 2 being a mirror image of the right.

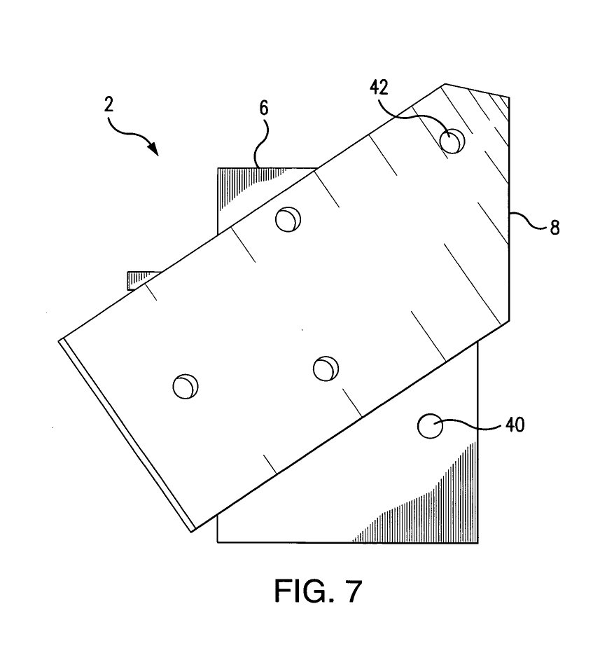

FIG. 7 is a bottom view of the mount 2 showing the relationship between the angle of the top plate 6 and the bottom plate 8. Again with a mirror image of the mount 2 being a pair it is clear that the knives 4 after mounting will essentially form a V shape. Visible again are the header mount openings therethrough 40 and the knife mounting openings therethrough 42.

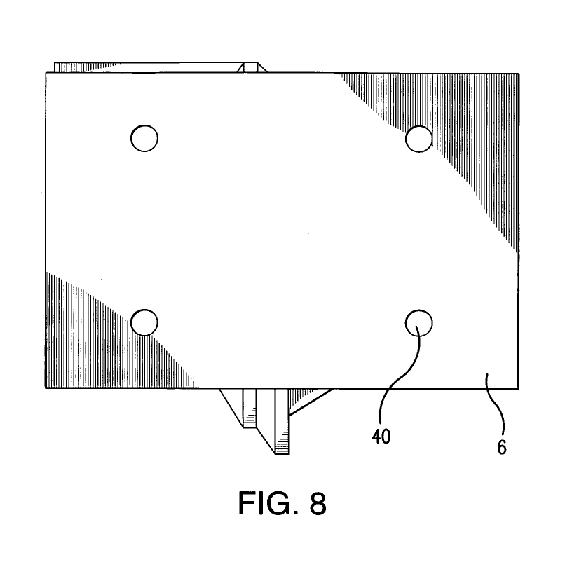

FIG. 8 is a top view of the mount 2. The top plate 6 mounts to the header 24 via the header mounting openings 40.

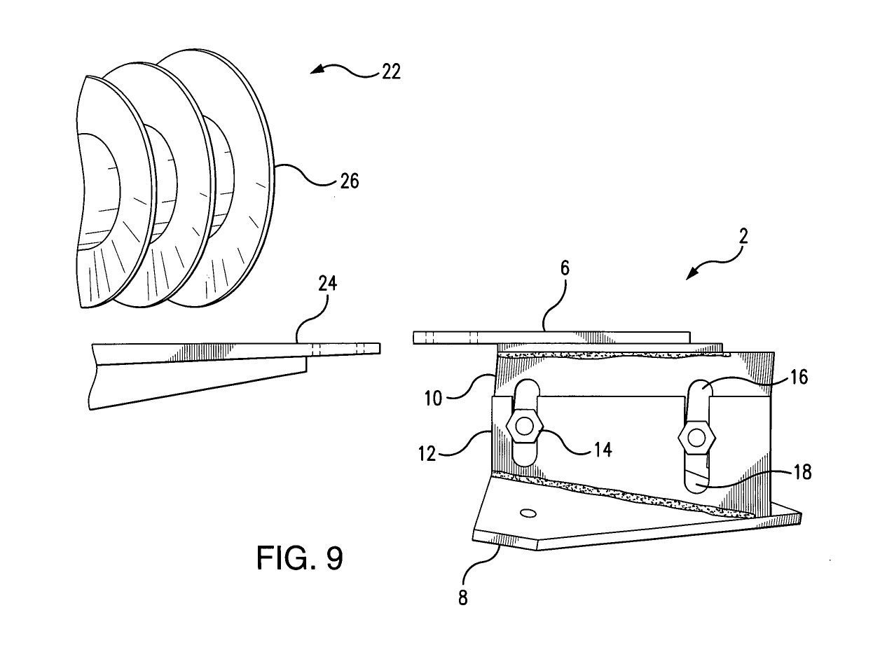

FIG. 9 is a side view of the mount 2 and where it mounts to the harvester 22. The top plate 6 is adaptable to the header 24 via the openings 40 in the mount 2. The augur 26 sits just behind the header 24 to move the beans into the combine 22. It is clear how the mount 2 attaches to the header. Also the relationship between the top plate 6 and the bottom plate 8 is clear with the elongated openings 16 and 18 and the respective risers 10 and 12 with the fasteners 14.

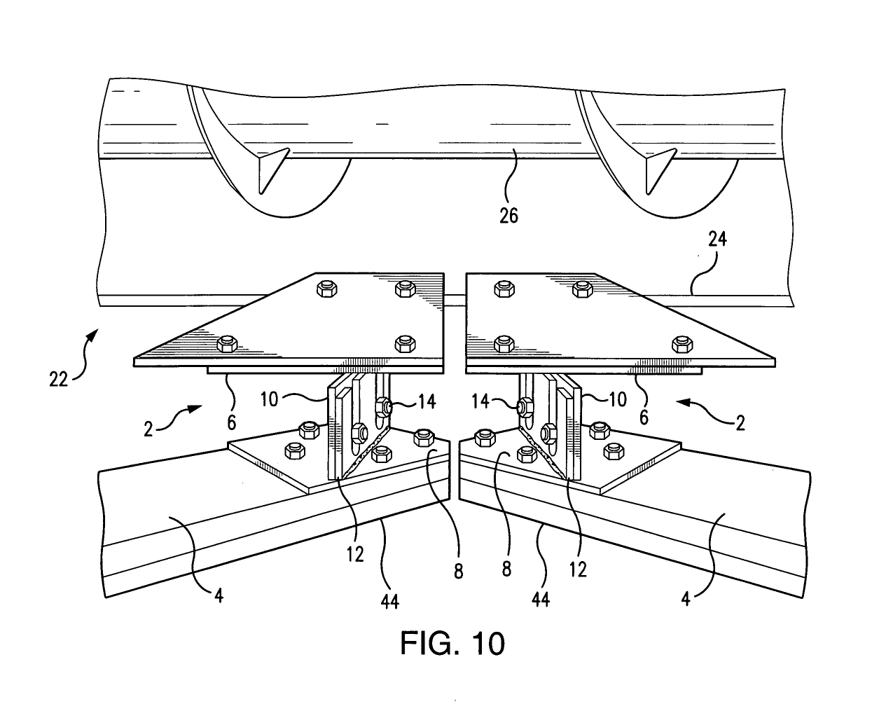

FIG. 10 is a frontal view of a pair of mounts 2 that form a mirror image of each other with the knives 4 attached and the mounts 2 being mounted to a harvester 22. This view clearly shows the relationship between the pair of mounts 2 and how the knives 4 when mounted form the V shape. FIG. 1 shows the direction of travel of the combine 22 with the knives 4 attached to the mounts 2 shown at T and an arrow on FIG. 1. Each mount 2 has a top plate 6 and a bottom plate 8. These plates 6 and 8 each have a respective riser 10 and 12. The risers 10 and 12 are attached the top plate 6 and the bottom plate 8 via fasteners 14 through their respective elongated openings 16 and 18. There is a gap between the mounts 2 and the knives 4, for allowing dirt and other debris' to flow through. The bean plants are cut about mid way along the knives 4 and because the knives 4 make a V-shaped terminus, and when the bean plants are fully cut they move onto the header 24 to be drawn into the augur 26 by the reel fingers 38 and into the combine 22 for processing.

Direct harvesting dry edible beans and the like is a one operational process by bean growers to reduce costs and labor when beans are ripe and ready to harvest. The inventive system disclosed herein replaces other methods that use multiple operations such as first undercutting with bean knives, windrowing, and then combining the beans. In addition to these multiple passes, there is the weather problem or rain delay, discoloring the bean seed and wind scattering the windrows.

The conventional, prior art, direct harvesting process uses a power operated combine attached in front with a header with sickle blades to cut, near the ground level, the bean plants and the convey then to the combine.

Because some of the bean pods grow lower on the plant and the sickle cannot operate near ground level because stones and dirt dull, damage and or break the sickle cutters, some of the bean pods are cut off and the bean seed is lost. Also the sickle cutters while severing the bean stalk against the sickle guards and more so with dulled or damaged sickle blades, results in high bean losses. This is where the majority of bean seeds are lost in conventional direct harvest. It is estimated that bean loss is about 3.5 bushel per acre.

The instant invention being a one operational dry bean harvesting process eliminates this waste and increases profit for the user. The sickle bat cutters are replaced with the instant invention bean knife mount and bean knives that run just into the top one inch of the soil allowing the cutting of the bean plant in a more appropriate position then guiding them into the harvester eliminating the loss of the bean pods and eliminating the other time consuming steps involved in conventional harvesting techniques. The instant invention also eliminated the shaking or shattering of the bean plant because the surrounding soil holds the plant stem firm and intact while it is being cut. This smooth cutting operation allows for longer use of the knives increasing time in the field without repair or replacement of the knives. The actual speed of the harvester can be increased without any increase in loss of the bean pods increasing productivity.

The knife which is attached to the bean knife mount cuts the bean plant about 12 inches from the combine's header. At a speed of three miles per hour, the combine travel speed, it takes less than one-half second from the time the bean plant is cut for it to be deposited on the header and then it will be augured to the combine.

What is claimed is:

1. A novel mounting device for bean knives, the mounting device comprising in combination:
a first flat metal plate having four corners, and a bottom, each corner having near it, an opening therethrough;
said first flat metal plate having permanently affixed to the bottom thereof, a second flat metal plate, said second flat metal plate being oriented vertically with regard to the flat plane of the bottom of the first flat metal plate; said second flat metal plate having at least two vertical slots therethrough;
a third flat metal plate having five corners, wherein at least four of the corners are square corners, and a top, each square corner having near it, an opening therethrough;
said third flat metal plate having permanently affixed to the top thereof, a fourth flat metal plate, said fourth flat metal plate being oriented essentially at an angle with regard to the flat plane of the third flat metal plate, said fourth metal plate having at least two vertical slots therethrough that align with the vertical slots of the second flat metal plate, there being a mechanical fastener inserted through the each set of vertical slots to rigidly fasten the second flat metal plate and the fourth flat metal plate together, wherein the angle of the fourth flat metal plate relative to the flat plane of the top of the third flat metal plate is within the range of 40° to 70°.

2. In combination, the novel mounting device as claimed in claim 1 and a shield plate, wherein the shield plate is mounted on a leading edge of the first flat metal plate.

3. In combination, the novel mounting device and the shield plate of claim 2 with a bean knife mounted on the bottom of the third flat metal plate.

4. In combination, the novel mounting device of claim 1 and a bean knife mounted on the bottom of the third flat metal plate.

5. The combination as claimed in claim 4 wherein the angle of the fourth flat metal plate relative to the third flat metal plate is 45° to 65°.

6. The combination as claimed in claim 4 wherein the angle of the fourth flat metal plate relative to the third flat metal plate is 50° to 60°.

7. The combination as claimed in claim 4 wherein the angle of the fourth flat metal plate relative to the third flat metal plate is 50°.

8. The combination as claimed in claim 4 wherein the angle of the fourth flat metal plate relative to the third flat metal plate is 60°.
